(19) United States
(12) Patent Application Publication
(10) Pub. No.: US 2007/0262593 A1
(43) Pub. Date: Nov. 15, 2007

(54) Security device

(75) Inventors: Paul Littrell, Fort Wayne, IN (US); Wanda K. Beard, Angola, IN (US); David L. Gilbert, Fort Wayne, IN (US)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: TydenBrammall, Angola, IN (US)

(21) Appl. No.: 11/417,036

(22) Filed: May 4, 2006

(51) Int. Cl. G09F 3/03

(52) U.S. Cl. 292/307 R

(57) ABSTRACT

A security device is described with a housing having a top wall and an intermediate wall that define a first bore. A bottom wall and the intermediate wall define a central cavity, a second bore, and an end cap receiving opening. The intermediate wall includes a recessed portion that defines a cusp at an end of the second bore interior to the housing. An end cap is disposed within the end cap receiving opening and has a hole therethrough. A resilient member is disposed within the central cavity adjacent to the end cap. A first securing member is disposed within the cavity adjacent to the resilient member. A second securing member is disposed adjacent to the first securing member. A cable has a first end fixedly secured within the first bore and a second end that is insertable through the second bore and a hole in the end cap.

### CROSS-REFERENCE TO RELATED APPLICATIONS

This application is a first-filed application and does not rely for priority on any other application.

### BACKGROUND OF THE INVENTION

1. Field of the Invention

This application relates to security devices. In particular, this application relates to security seals for rail cars and tanker trucks, for example, that incorporate a cable. In the shipping industry, security seals (or security devices) are also known as mechanical seals.

2. Description of the Related Art

Security seals are used widely in the shipping industry to provide tamper-resistant closures for many different types of rail cars, tanker trucks, and other types of shipping and freight containers. In one common example, one or more security seals are placed on the exterior of a rail car or tanker truck after the contents of the container are verified.

There are many reasons for which a shipper might want (or be required) to seal a rail car or tanker truck after contents are placed therein. For example, there is often a need to prevent tampering with the contents of the rail car or tanker truck. In the case of a tanker truck, it is often desirable for a shipper to ensure that the liquid contents are maintained in a pristine condition during shipment. In addition, security seals are often placed on empty tanker trucks after the interior of the tanker has been cleaned.

Regardless of the reasons for which a security seal is employed, the security seal is expected to perform its intended function - namely to discourage opening of the rail car or tanker truck and to indicate if the rail car or tanker truck has been opened during transit for any reason. If the seal is broken, the recipient of the rail car or tanker truck will be able to quickly and easily determine that the rail car or tanker truck has been opened so that the recipient may reject the shipment, take appropriate corrective action, etc.

In the specific case of a liquid shipping container, such as a tanker truck, there are a host of reasons for which a secure seal may be needed. In one example, a dairy may be shipping milk from the point of origin (i.e., the dairy) to a point of bottling. To make sure that the shipment remains pristine from the point of origin to the bottler, the shipper will require security seals on the inlet and outlet openings into the liquid transport container. If the seals are in tact at the bottling point, the bottler can rest assured that the shipment has not been violated.

While the prior art contains many examples of different types of security seals, there is a continuing demand for security seals that provide increased resistance to tampering.

Other issues exist in the art with respect to security seals, as would be appreciated by those skilled in the art.

### SUMMARY OF THE INVENTION

It is, therefore, an aspect of the present invention to resolve one or more of the issues noted above with respect to prior art security seals.

It is another aspect of the invention to provide a security seal that resists tampering.

As made more clear from the discussion that follows, one aspect of the present invention is to provide a security device with a housing having a bottom wall, an intermediate wall, and a top wall. The top wall and the intermediate wall define a first bore. The bottom wall and the intermediate wall define a central cavity, a second bore, and an end cap receiving opening. The intermediate wall includes a recessed portion that defines a cusp at a predetermined distance interior to an end of the second bore within the housing. An end cap is disposed within the end cap receiving opening, the end cap defining a hole therethrough. A resilient member is disposed within the central cavity adjacent to the end cap. A first securing member is disposed within the cavity adjacent to the resilient member. A second securing member is disposed within the cavity adjacent to the first securing member. A cable is included with a first end and a second end. The first end is fixedly secured within the first bore. The second end is insertable through the second bore and the hole in the end cap.

Another aspect of the security seal of the invention provides that the housing and the end cap both comprise one from a variety of materials including, but not limited to, zinc or a zinc-containing alloy.

In still another aspect of the invention, the resilient member is a spring made from one of a variety of different materials including, but not limited to, steel or an iron-containing alloy.

In a further aspect of the invention, the resilient member is a spring that includes a first leg extending from a free end to a first bend, a second leg extending from the first bend to a second bend, a third leg extending from the second bend to a third bend, a fourth leg extending from the third bend to a fourth bend, a fifth leg extending from the fourth bend to a fifth bend, a sixth leg extending from the fifth bend to a sixth bend, and a seventh leg extending to a termination point from the sixth bend.

One further aspect of the invention provides for a construction where the free end of the first leg of the spring guides the cable through the central cavity after the cable has been inserted through the second bore but before the cable exits through the hole in the end cap.

Another aspect of the invention provides, at least in one exemplary embodiment, that the second leg of the spring have a curve with a constant radius of curvature.

Still another aspect of the invention provides that the first securing member is a first disk and that the second securing member is a second disk.

A further aspect of the invention provides that the first disk is made from one of a variety of materials including, but not limited to, aluminum or an aluminum-containing alloy. The first disk may have a surface that presents one from a variety of different surface finishes including, but not limited to, a smooth surface. The second disk also may be constructed from one of a variety of different materials including, but not limited to, steel or an iron containing alloy. Moreover, the second disk may have a surface that presents one from a variety of different surface finishes including, but not limited to, a knurled surface.

One further aspect of the invention provides that the first securing member is a disk and the second securing member is trapezoidally-shaped.

Yet another aspect of the invention provides that the trapezoidally-shaped member includes at least one barb on a surface facing the cable and at least one barb on a surface facing the disk.

In another aspect of the invention, the first securing member is trapezoidally-shaped and the second securing member is a disk.

Further, it is another aspect of the invention to provide a construction where the first securing member includes at least one barb on a surface facing the cable.

An additional aspect of the invention provides a construction where the first securing member and the second securing member are both trapezoidally-shaped members.

In an alternative embodiment of the invention, the resilient member is a coil spring.

Another aspect of the invention provides that the bottom wall of the housing defines a first inclined surface adjacent to the end cap receiving opening and a second inclined surface adjacent to the first inclined surface, the second inclined surface being angled to a greater degree than the first inclined angle.

In still another aspect of the invention, the first inclined surface is angled between about 3 to 13 degrees from a reference line and the second inclined surface is angled between about 19 to 29 degrees from the reference line.

As another aspect of the invention, the first inclined surface is angled between about 6 to 10 degrees from a reference line and the second inclined surface is angled between about 22 to 26 degrees from the reference line.

In yet another aspect of the invention, the first inclined surface is angled at about 8 degrees from the reference line and the second inclined surface is angled about 24 degrees from the reference line.

Still another aspect of the invention provides that the end cap is secured in the housing by crimping the housing around the end cap.

In yet another aspect of the invention, the housing defines at least one exterior surface onto which identification information may be disposed.

In still another aspect of the invention, the cable is made from a plurality of wires stranded together. A single strand wire also may be employed.

Still further aspects of the invention will become apparent from the description of the embodiments of the invention that follows.

### DESCRIPTION OF THE DRAWINGS

The present invention will be described with reference to drawings appended hereto, in which:

FIG. 1 is a cross-sectional front view of one embodiment of the security seal of the present invention, illustrating the interrelation between various of the components disposed within a housing;

FIG. 2 is a cross-sectional front view of the housing of the security seal illustrated in FIG. 1;

FIG. 3 is a front view of a spring disposed within the housing of the security seal illustrated in FIG. 1;

FIG. 4 is a front view of a first disk disposed within the housing of the security seal illustrated in FIG. 1;

FIG. 5 is a perspective view of a second disk disposed within the housing of the security seal illustrated in FIG. 1;

FIG. 6 is a first end view of the exterior of the housing of the security seal illustrated in FIG. 1;

FIG. 7 is a top view of the exterior of the housing of the security seal illustrated in FIG. 1;

FIG. 8 is a rear view of the exterior of the housing of the security seal illustrated in FIG. 1;

FIG. 9 is a front view of the exterior of the housing of the security seal illustrated in 1;

FIG. 10 is cross-sectional side view of an end cap for the security seal illustrated in FIG. 1;

FIG. 11 is a top plan view of the end cap illustrated in FIG. 10;

FIG. 12 is a cross-sectional front view of a second embodiment of the security seal illustrated in FIG. 1;

FIG. 13 is a cross-sectional front view of a third embodiment of the security seal illustrated in FIG. 1;

FIG. 14 is a cross-sectional front view of a fourth embodiment of the security seal illustrated in FIG. 1; and

FIG. 15 is a cross-sectional front view of a fifth embodiment of the security seal illustrated in FIG. 1.

### DESCRIPTION OF EMBODIMENTS OF THE INVENTION

Various embodiments of the present invention will be described in connection with the figures appended hereto. The discussion of specific embodiments, however, should not be understood to convey that the invention is limited solely to those embodiments. Moreover, any reference to one embodiment or an aspect of one embodiment as “preferred” should not be understood to limit the scope of the invention in any way. To the contrary, as will be appreciated by those skilled in the art, the invention encompasses all equivalents of the structures, materials, and methodologies discussed, as would be appreciated by those skilled in the art.

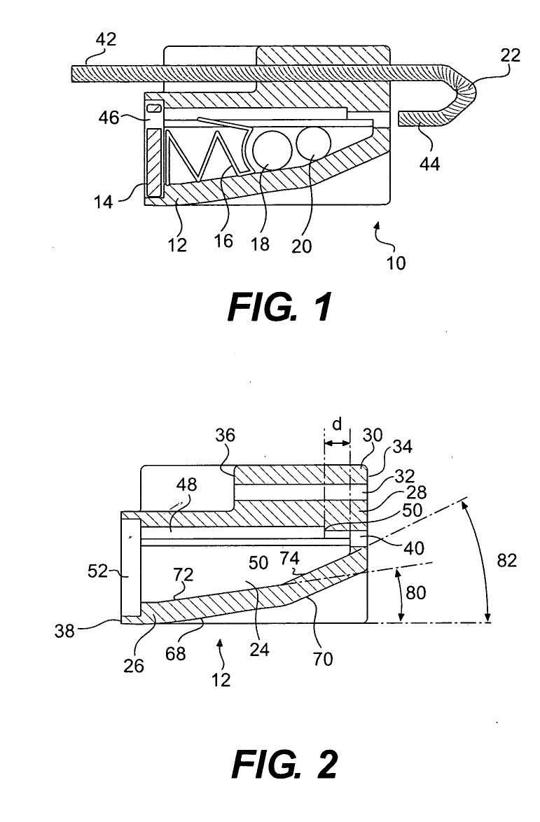

A first embodiment of the invention is illustrated in FIG. 1, which depicts a cross-section of a security seal 10. There are six components that make up the security seal 10: a housing 12, an end cap 14, a spring 16, a first disk 18, a second disk 20, and a cable 22. The six components of the security seal 10 cooperate together to reliably secure an access opening, such as a door or hatch, in a freight or shipping container.

The cable 22 in the preferred embodiment is a 1/16″ (inch) steel, stranded wire cable. As would be appreciated by those skilled in the art, other sizes of cable 22 may be employed without departing from the scope of the present invention. In addition, the cable 22 may be made from materials other than steel without departing from the scope of the present invention. For example, the cable may be made from stranded wires of aluminum, copper, or alloys thereof.

While the preferred embodiment of the security seal 10 incorporates a stranded wire cable where the strands are made from a metal material, non-metallic materials may be employed, as would be appreciated by those skilled in the art. For example, the strands may be made from a synthetic material such as an aramid material, referred to commonly as Kevlar® (Kevlar® is a registered trademark for an aramid material manufactured by DuPont.) Monofilament plastics or composite materials also may be employed.

Alternatively still, the cable 22 may include strands where one or more of the strands are made from different materials than others of the strands For example, it is contemplated that some of the strands in the cable 22 may be made from steel while others may be made from an aramid material. As would be appreciated by those skilled in the art, still other variations are possible and these variations are intended to be encompassed by the invention.

In one further variation contemplated for the cable 22, the cable 22 need not be made up of a group of wires stranded together. Instead, the cable 22 may be constructed from a single strand of material.

As illustrated in FIG. 2, the housing 12 is a generally rectangular body with a central cavity 24. The central cavity 24 is generally trapezoidally-shaped. The central cavity 24 is defined by a bottom wall 26 and an intermediate wall 28.

The housing also defines a top wall 30. The top wall 30 and the intermediate wall 28 define a bore 32 between them. The bore 32 preferably is a cylindrically-shaped hole extending from the right edge 34 (as illustrated in FIG. 2) to an intermediate position 36 between the right edge 34 and a left edge 38 of the housing 12. The bore 32 accepts one end of the cable 22, as illustrated in FIG. 1. To secure the cable 22 in the bore 32, the housing 12 preferably is mechanically deformed to crimp the cable 22 between the walls 28, 30 of the bore 32 by suitable machining, as would be appreciated by those skilled in the art.

The housing 12 preferably is a cast structure made from a material such as zinc or a zinc-containing alloy. Zinc is a preferred material for several reasons. First, zinc is a light-weight material, which results in a light-weight construction. Second, zinc is sufficiently strong to resist breaking or tampering. Third, zinc is corrosion-resistant, which is helpful since most rail cars and tanker trucks are exposed to a variety of environmental conditions such as rain, snow, ice, and salt (when applied to roads, for example, under wintry conditions). Fourth, zinc is a relatively inexpensive material. Fifth, zinc is easily cast in the shape of the housing 12. Other advantages associated with the use of zinc for the housing 12 will be appreciated by those skilled in the art.

It is also contemplated that the housing 12 may be fashioned from an alternative material such as iron, aluminum, steel, magnesium, titanium, or a metal alloy, to list but a few contemplated materials. Non-metallic materials also may be employed such as plastics, ceramics, aramids, and composites, depending upon the strength and malleability of the material selected or required.

As noted above, the housing 12 preferably is cast as a single unit. As a cast structure, the housing 12 is a unitary structure that is particularly resistant to tampering or breaking. Were the structure made from two or more separate pieces welded or adhered together, there is an increased probability that the housing 12 could be opened along one or more of the seams joining the pieces together. It is for this reason that a cast structure for the housing 12 is preferred. Of course, as would be appreciated by those skilled in the art, the housing 12 may be assembled from several different pieces without departing from the scope of the invention.

In one variation of the security seal 10, the housing 12 may be coated with plastic, paint, or other suitable material to improve the resistance of the housing 12 to corrosion. In addition, a coating material may assist in providing an indication if someone has tried to tamper with the security seal 10, because the coating may be selected to show scratches or other irregularities that may be introduced by a person attempting to open the security seal 10. In addition, the coating may assist with the placement of label information to the housing 12, as discussed in greater detail below.

Returning to FIG. 2, the bore 32 extends through a portion of the housing 12 that extends between the right edge 34 and an intermediate position 36 between the right edge 34 and the left edge 38. This construction is intentional in the preferred embodiment of the security device 10. It is not necessary for the housing 12 to incorporate a structure in which the bore 32 extends completely from the left edge 38 to the right edge 34 for at least two reasons. First, the bore 32 need only extend through enough of the housing 12 to provide sufficient material so that the housing 12 may be crimped onto the cable 22. Second, from a manufacturing standpoint, it is always preferable to use less material in the construction of a device such as the security seal 10. Less material results in a security seal 10 that is lighter in weight. Also, by using less material, the cost to manufacture the security seal 10 may be reduced. Of course, the housing 12 may be designed so that the bore 32 extends completely from the left edge 34 to the right edge 38 (or any other intermediate position) without departing from the scope of the present invention.

As also illustrated in FIG. 2, a cable bore 40 extends into the central cavity 24 from the right side 34 of the housing 12. As the first end 42 of the cable 22 is rigidly secured within the housing 12 via mechanical deformation of the housing 12, a second end 44 of the cable 22 is free and will, therefore, also be referred to as the free end 44 of the cable 22. The free end 44 of the cable 22 is inserted into the bore 40 so that the free end 44 passes through the central cavity 24 and exits through a hole 46 in the end cap 14, thereby becoming exposed outside of the left edge 38 of the housing 12. Once the free end 44 of the cable 22 is exposed, a person may pull on the free end 44 of the cable 22 to secure the security seal 10 to a selected freight container (not illustrated).

The central cavity 24 of the housing 12 includes a recessed portion 48 that extends from a cusp 50 to an end cap receiving opening 52. The cusp 50 provides a more secure operation, as discussed in greater detail below. The cusp 50 preferably is positioned a predetermined distance d from the interior edge of the bore 40. As would be appreciated by those skilled in the art, the distance d will depend on a number of factors including the rigidity of the housing 12 and the flexure and hardness properties of the cable 22.

The end cap 14, which is illustrated in greater detail in FIGS. 10 and 11, is inserted into the end cap receiving opening 52 after the first and second disks 18, 20 and the spring 16 are inserted into the central cavity 24 within the housing 12. The end cap 14 may be secured in the end cap receiving opening 52 via any of a number of suitable means. In the preferred embodiment, the end cap 14 is secured in the end cap receiving opening 52 by mechanically deforming (or crimping) the edges of the end cap receiving opening 52 over the edges of the end cap 14. Mechanical deformation is the preferred method for securing the end cap 14 in the housing 12, because mechanical deformation is well suited to discourage tampering with the security seal 10.

Of course, as would be appreciated by those skilled in the art, the end cap 14 may be secured in the end cap receiving opening 52 by other means including welding or with a suitable adhesive. These latter methods, however, are less preferred for a couple of reasons. As would be appreciated by those skilled in the art, adhesives and welding present a greater opportunity for a well-equipped person to open the security device 10 and reseal the device. Adhesives present an additional problem in that the adhesive, if not applied in an appropriate quantity, may ooze into the central cavity 24 and may interfere with the operation of the spring 16, the first disk 18, or the second disk 20. Due to the heat required, welding may also bind the spring 16, the first disk 18, or the second disk 20, thereby interfering with the operation of the security device.

Referring to FIG. 11, the end cap 14 has an elongated body 54 with a first edge 56 that is generally squared-off and a second edge 58 that is rounded around the hole 46. The end cap 14 preferably is made of the same material as the housing 12. In the preferred embodiment of the security seal 10, therefore, the end cap 14 preferably is made from zinc or a zinc-containing alloy. Of course, the end cap 14 could be made from any other suitable material including aluminum, steel, iron, magnesium, titanium, plastic, ceramic, or a composite material. Those skilled in the art will readily appreciate the wide variety of materials that may be used to fashion the end cap 14. The list of potential materials, therefore, should not be considered as exhaustive of all of the materials contemplated for construction of the end cap 14.

As illustrated in the cross-section of the end cap 14 in FIG. 10, the end cap 14 preferably is a solid body. The hole 46 may be entirely cylindrical in shape or may be provided with chamfered edges 60. If provided, the chamfered edges 60 assist in threading the cable 22 through the hole 46 in the end cap 14. Accordingly, the chamfered edges 60 are preferred for the construction of the end cap 14.

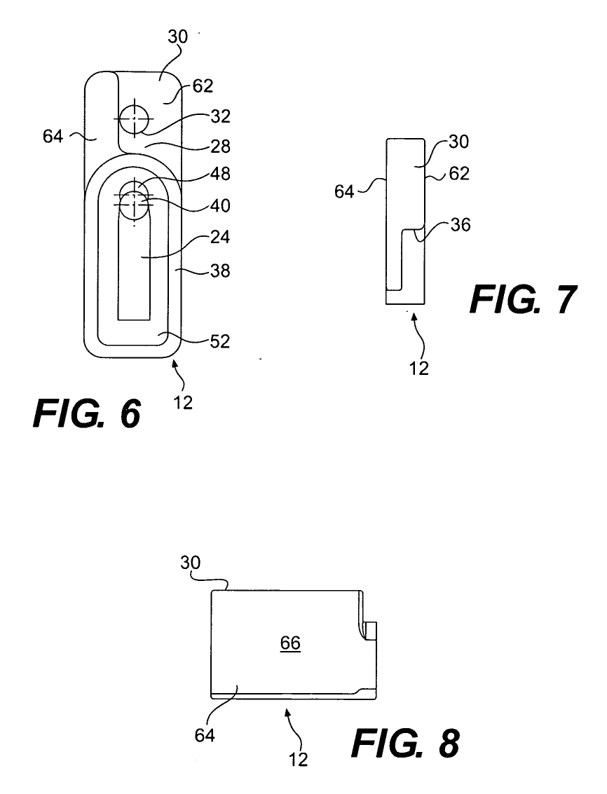

The construction of the housing 12 will now be described in connection with FIGS. 6-9 to provide a greater understanding of the details of the security seal 10.

FIG. 6 illustrates a left end view of the housing 12. The end cap receiving opening 52 is easily appreciated in this end view. In addition, the relative juxtapositioning of the bores 32, 40 is apparent. The relative size and position of the recessed portion 48 also may be appreciated in this end view. The intermediate wall 28 and the top wall 30 also are visible, as are a front wall 62 and a rear wall 64, all of which surround the bore 32. The central cavity 24 is also visible in this view.

FIG. 7 illustrates a top view of the security seal 10. The top wall 30 is visible as is the intermediate position 36. The rear wall 64 extends beyond the intermediate position 36, as illustrated.

FIG. 8 is a rear view of the security seal 10 of the invention. The rear view illustrates the rear wall 64, which is a generally-rectangular wall. The rear wall 64 presents a broad surface onto which identification information may be applied. In the preferred embodiment of the security seal 10, identification information is indelibly marked onto the exterior surface 66 of the rear wall 64. Preferably the identification information is etched into the exterior surface 66 so that the identification information cannot be altered. Mechanical etching may be used. Alternatively, laser etching may be employed. As would be appreciated by those skilled in the art, the exterior surface 66 may by inscribed with the identification information via numerous other means.

It is also contemplated that the identification information may be applied via an inkjet printer or via a label. Printing is less preferred because the printed text may be altered. Similarly, labels are less preferred because it may be possible for the label to be removed and transferred to another security seal 10, thereby undermining the security feature of the seal 10.

Regardless of the manner in which the identification information is applied to the exterior surface 66, it is preferred that the identification information include a unique serial number proprietary to the shipper. As noted, it is preferred that the identification information be indelibly applied to prevent, or at least make difficult, alteration or duplication of the identification information.

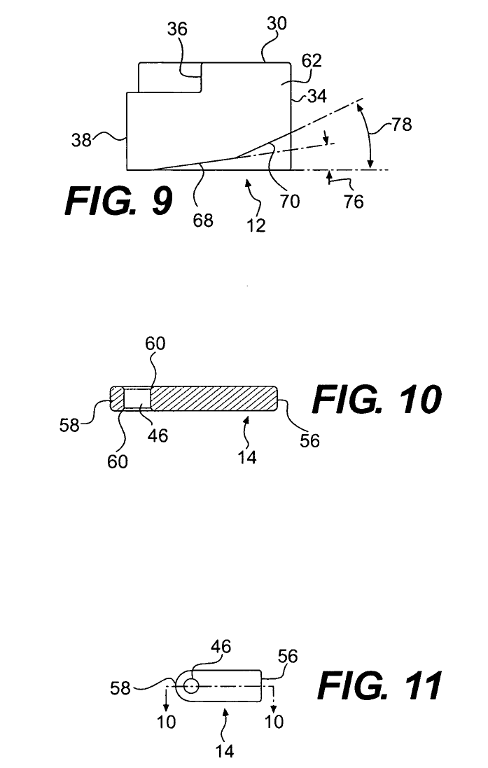

FIG. 9 is a front view of the exterior of the housing 12. The right edge 34 and the left edge 38 are visible, as is the intermediate position 36. Also visible is a first inclined bottom edge 68 and a second inclined bottom edge 70. The first inclined bottom edge 68 follows generally the inclination of a first inclined surface 72 within the central cavity 24. Similarly, the second inclined bottom edge 70 follows generally the inclination of a second inclined surface 74 within the central cavity 24.

A first angle 76 of inclination of the first inclined bottom edge 68 preferably is the same as a first angle 80 of the first inclined surface 72. In the embodiment illustrated, each of the first angles 76, 80 preferably is about 8° (degrees). Each of the second angles 78, 82 preferably is about 24°. As would be appreciated by those skilled in the art, the first angles 76, 80 and the second angles 78, 82 need not be 8° and 24°. Moreover, the first angles 76, 80 need not be the same. Similarly, the second angles 78, 82 need not be the same.

With respect to the first and second angles 80, 82 of the first and second inclined surfaces 72, 74, the following ranges are preferred. It is preferred that the first angle be between about 3° and 13°. It is more preferred that the first angle be between about 6° and 10°. As noted, it is most preferred that the first angle 80 be about 8°. For the second angle 82, it is preferred that the angle be between about 19° and 29°. It is more preferred that the second angle 82 be between about 22° and 26°. As noted, the most preferred angle is 24°.

With respect to the first angles 76, 80, a magnitude of 8° was selected for both to establish a uniform thickness for the bottom wall 26. As noted above, one reason for this design choice is to utilize the minimum amount of material when forming the portion of the bottom wall 26 that defines the first inclined surface 72. Similarly, by designing the housing 12 so that the second angles 78, 82 are both 24°, the thickness of the bottom wall 26 that defines the second inclined surface 74 made be made uniform also to minimize the amount of material needed to cast the housing 12. As would be appreciated by those skilled in the art, the first angles 76, 80 need not be the same nor do the second angles 78, 82 need to be the same to construct the housing 12 for the security seal 10.

With respect to the first and second angles 80, 82, it is noted that these angles depend on a variety of factors including the respective sizes of the first disk 18 and the second disk 20. As would be appreciated by those skilled in the art, therefore, the angles 80, 82 may be varied without departing from the scope of the invention. While specific angles are discussed, it is intended that the invention not be limited solely to the magnitudes listed, as would be appreciated by those skilled in the art.

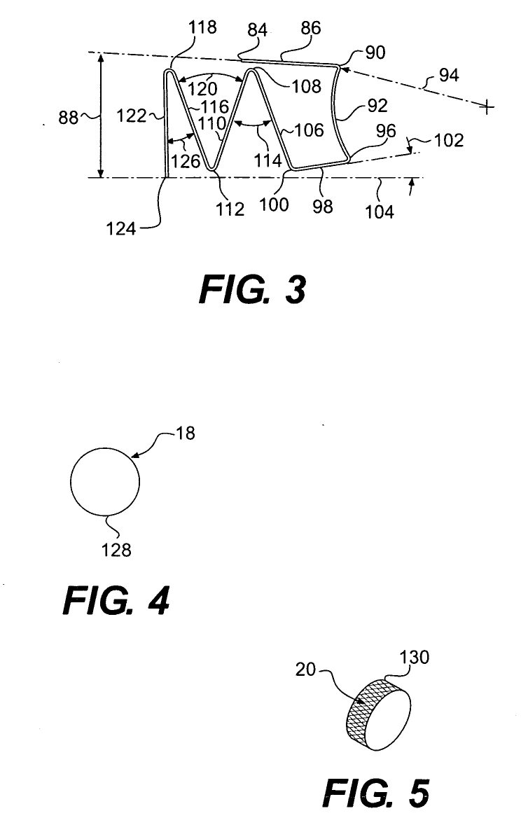

FIG. 3 illustrates the spring 16 that is depicted in FIG. I as a part of the first embodiment of the security seal 10. The spring 16 preferably is a metal spring that is shaped in the manner illustrated in FIG. 3. Preferably, the spring 16 is constructed from a single strip of resilient material, such as steel. As would be appreciated by those skilled in the art, however, the spring 16 need not be made from steel. Other metal materials, such as zinc, aluminum, copper, iron, nickel, titanium, metal alloys, plastic, composites, etc. may be employed without departing from the scope of the invention. Moreover, while not preferred, the spring 16 may be constructed from more than one individual segment. It is possible that multiple segments might be assembled together to form the spring 16, as would be appreciated by those skilled in the art.

It is preferred to manufacture the spring 16 from a single strip of flat spring stock for several reasons. Among them, it is possible to control the spring constant so that an appropriate amount of force is applied to the first disk 18 and the second disk 20 for proper operation of the security seal 10. In addition, manufacturing the spring 16 from a single strip of spring stock is cost effective.

The spring 16 has a first end 84 that is disposed at the end of a first leg 86, which is angled from a horizontal reference line by a first leg angle 88. The first leg angle 88 is preferably between about 1° and 7°. More preferably, the first leg angle 88 is between about 3° and 5°. Most preferably, the first leg angle 88 preferably is about 4°. Of course 4° is not required to practice the invention. Moreover, it is contemplated that different angles may be needed depending upon the size of the security seal 10 employed and the materials used to construct the security seal 10 and the spring 16.

As shown in FIG. 3, the first leg 86 extends to a first bend 90, whereupon the spring 16 is formed into a second leg 92.

The second leg 92 preferably is imprinted with a curved shape to interface with the exterior surface of the first disk 18. The curve of the second leg 92, at least for the first embodiment of the security seal 10, preferably has a constant radius of curvature 94. As would be appreciated by those skilled in the art, however, a constant radius of curvature 94 is not required to practice the invention.

To practice the invention, it is not necessary for the second leg to have a curve with a constant radius of curvature 94. It is contemplated that the second leg 92 may be a straight leg without any bends at all. In still another contemplated embodiment, the second leg 92 could be V-shaped, oval, elliptical, polyhedral, etc. It is contemplated that the second leg 92 may take any of a number of different shapes without departing from the scope of the invention.

The second leg 92 extends to a second bend 96. From the second bend 96, the spring 16 has a third leg 98 that extends to a third bend 100. As illustrated, the third leg 98 is angled at a third leg angle 102 of about 8° from a horizontal reference line 104. The third leg angle 102 compliments the angle 80 of the first inclined surface 72 against which the third leg 98 abuts. It is preferred that the angle 102 of the third leg 98 compliment the angle 80 of the first inclined surface 72, but this is not required to practice the invention.

A fourth leg 106 extends between the third bend 100 and a fourth bend 108. A fifth leg 110 extends between the fourth bend 108 and a fifth bend 112. The fourth leg 106 and the fifth leg 110 form an angle 114 between them that is preferably about 39°. A sixth leg 116 extends from the fifth bend 112 to a sixth bend 118. An angle 120 between the fifth leg 110 and the sixth leg 116 preferably is about 39°. A seventh leg 122 extends from the sixth bend 118 to an end point 124 of the spring 16. The seventh leg 122 preferably is disposed perpendicularly to the horizontal reference line 104 and forms an angle 126 that is about half that of the angles 114, 120. The seventh leg 122 abuts against the interior surface of the end cap 14 when the end cap 14 is disposed within the end cap receiving opening 52. As would be appreciated by those skilled in the art, the angles 114, 120, 126 are merely preferred for the embodiment illustrated in FIGS. 1 and 3 and are not required to practice the invention. Moreover, while the angles 114 and 120 are the same in the illustrated embodiment, they need not be the same to practice the invention.

As would be appreciated by those skilled in the art, the angles 88, 102, 114, 120, and 126 are merely exemplary of the spring 16 depicted in FIG. 3. If the central cavity 24 is provided with a different topography than illustrated and described, the spring 16 would need to be reshaped accordingly. As a result, the angles 88, 102, 114, 120, and 126 would not necessarily follow the angular preferences listed above.

As should be apparent from the discussion herein, the spring 16 need not follow the shape described herein. Those skilled in the art would readily recognize that the spring 16 may take any shape and include any number of bends and angles as needed for a particular application. Accordingly, it is intended for the invention to encompass any spring, regardless of the shape employed.

Factors that will affect the shape of the spring 16 include, but are not limited to the spring force required, the thickness of the spring stock used to manufacture the spring 16, the temper of the spring material, the hardness of the spring material, whether or not the spring is made from a single material or a combination of different materials, etc. As would be appreciated by those skilled in the art, there are a wide variety of permutations possible and all of them are intended to fall within the scope of the invention.

FIG. 4 illustrates a side view of the first disk 18. The first disk 18 preferably is made from a malleable (or deformable) metal such as aluminum or an aluminum-containing alloy. Of course, as would be appreciated by those skilled in the art, other malleable metals may be employed such as, for example, lead, copper, iron, or any alloys thereof. In addition, other malleable materials may be employed such as rubber, plastic, composite materials, or the like.

FIG. 5 provides a perspective illustration of the second disk 20. The second disk 20 preferably is made from a material that is harder than the material used for the first disk 18. In the preferred embodiment, cold-rolled steel is used for the second disk 20. As would be appreciated by those skilled in the art, steel need not be used for the second disk 20. Other materials such as titanium, plastic, composites, ceramics, etc., my be used for the second disk 20 without departing from the scope of the present invention.

The first disk 18 preferably has a smooth circumferential surface 128. The circumferential surface 130 of the second disk 20 preferably is knurled, as illustrated. With these surface finishes are preferred, they are not required to practice the invention. The surface 128 of the first disk 18 may be knurled, roughened, geared, etc. without departing from the invention. Similarly, while it is preferred that the surface 130 of the second disk be knurled, other options are available including roughening, gearing, etc. It is also contemplated that the surface 130 of the second disk may be smooth, just as with the preferred embodiment of the first disk 18.

Operation of the security seal 10 will now be described with reference to FIG. 1. The following provides a summary of what occurs within the housing 12 during operation of the security seal 10. The present invention, however, should not be limited solely to this discussion, should it be discovered later that the actual operation of the security device differs from what is described herein. Moreover, other contemplated embodiments may operate in a different manner, as would be appreciated by those skilled in the art.

When the free end 44 of the cable 22 is inserted into the bore 40, it first passes the cusp 50 before moving past the second disk 20 and the first disk 18, respectively. Since the free end 44 of the cable 22 touches on the circumferential surface 130 of the second disk 20 and the circumferential surface 128 of the first disk 18, the free end 44 of the cable 22 pushes the two disks 18, 22 toward the end cap 14. The spring 16 compresses in response to the force applied to the disks 18, 20. As the spring 16 compresses, the free end 44 of the cable 22 is permitted to travel through the central cavity 24 of the housing 12 until the free end 44 passes through the hole 46 in the end cap 14.

As may be appreciated by FIG. 1, as the free end 44 of the cable 22 passes the spring 16, the cable 22 will exert a force on the first leg 86 of the spring 16 to compress the first leg 86 of the spring 16 toward the first inclined surface 72. The first leg 86 of the spring 16 guides the free end 44 of the cable 22 through the central cavity 24 and through the hole 46.

Once the free end 44 of the cable 22 exits from the housing 12, the person attaching the security seal 10 to a rail car or tanker truck will pull on the free end 44 until the cable 22 is cinched in place. At this point, it is undesirable for the cable 22 to travel in the reverse direction. In other words, once cinched in place, it is undesirable for the cable 22 to be loosened because this suggests that the security device 10 may not be performing its intended function. There are a number of features incorporated into the security device 10 to prevent the cable 22 from being loosened once the security device 10 has been secured.

Once the free end 44 of the cable 22 has been pulled through the housing 12, a reverse movement of the cable 22 will trigger several responses. The knurled circumferential surface 130 of the second disk 20 will begin to grip onto the body of the cable 22. As an increasingly greater force is applied to the cable 22 that tends to pull the cable 22 out from the bore 32, the second disk 20 will bite further into the cable 22.

The spring 16 exerts a force on the first disk 18 and the second disk 20 to comporess the disks 18, 20 toward the cusp 50. The force is applied to the first disk 18, which applied that pressure to the second disk 20. Pressure from the first disk 18 causes the second disk 20 to bite into the cable 22, compressing the cable 22 between the second disk 20 and the cusp 50. Since the first disk 18 preferably is made from a material that is more malleable than that of the second disk 20, and since the second disk 20 is provided with a knurled circumferential surface 130, the knurled surface 130 on the second disk 20 begins to deform the circumferential surface 128 of the first disk 18, thereby binding the first disk 18 to the second disk 20.

In summary, when a force is applied to the cable 22 in an effort to unthread the cable 22 from the housing 12, the spring 16, the first disk 18, and the second disk 20 cooperate with one another to set the cable against the cusp 50.

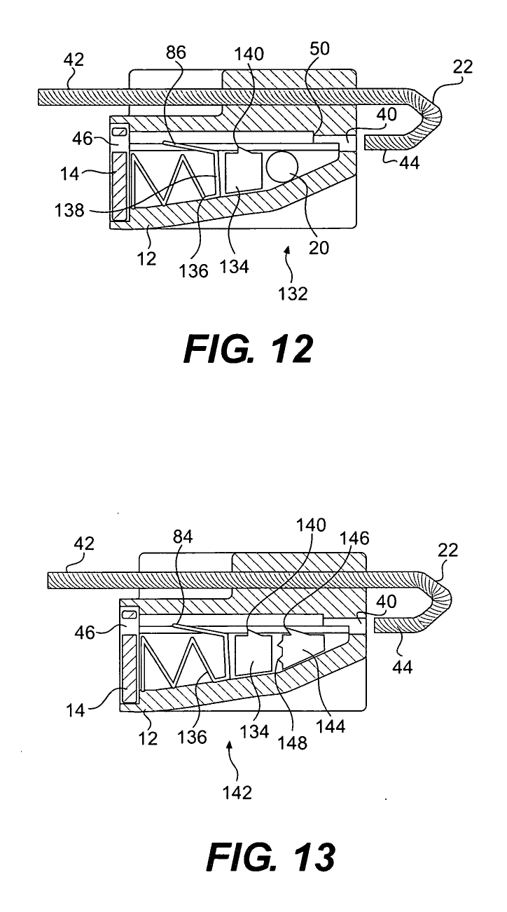

There are a number of additional embodiments for the security seal 10 of the present invention. The alternative embodiments are discussed in connection with FIGS. 12-15. To facilitate an understanding of the additional embodiments described herein, reference numbers for structures in the embodiments that are shared in common with the security seal 10 will be the same.

In the embodiments that are discussed below, there are three structures that are changed from the first embodiment, the spring 16, the first disk 18, and the second disk 20. As a convention, since the terms “spring” and “disk” are not general to all of the embodiments, the following terms are used to facilitate an understanding of the invention and the claims that follow. Specifically, “resilient member” is employed as a broad generic term for any structure that may be compressed by a force and, upon removing the force, return at least to a degree, to the original state before the force was applied. The spring 16 is one type of resilient member that may be employed for the security seal of the present invention. Since the first and second disks 18, 20 assist in securing the cable 22 within the housing 12, the first and second disks 18, 20 are specific examples of “securing members.” Accordingly, the first disk 18 is referred to as a first securing member 18. In addition, the second disk 20 is referred to as a second securing member 20.

FIG. 12 illustrates a second embodiment of the invention, a security seal 132. In this embodiment, the housing 12 is constructed in the same manner as the housing 12 in the first embodiment. The cable 22 is the same steel 1/16″ cable as in the first embodiment. The second disk 20 is also the same, including the knurled surface 130. The first disk 18 has been replaced with a trapezoidal member 134. In addition, the spring 136 has been modified from the shape of the spring 16. In particular, the second leg 92 has been modified to remove the radius of curvature 94. In its place, a second leg 138 is a straight leg section that is disposed parallel to the seventh leg 122. In this illustrated embodiment, the trapezoidal member 134 includes a barb 140 to assist in securing the cable 22 in the housing 12. The barb 140 is not required, however, to practice the present invention.

In operation, the components of the security seal 132 behave in essentially the same manner as the components of the security seal 10. Specifically, when the free end 44 of the cable 22 is inserted through the bore 40, the free end 44 of the cable will exert a force on the trapezoidal member 134 (the first securing member) and the second disk 20 (the second securing member) to push the first and second securing members 134, 20 against the second leg 138 of the spring 136. In addition, the free end 44 of the cable 22 presses the first leg 86 of the spring toward the bottom of the housing 12. This facilitates insertion of the free end 44 of the cable through the housing 12 until the free end 44 protrudes outside of the end cap 14.

When a force is applied in the reverse direction, the spring 136 compresses the trapezoidal member 134 and the second disk 20 together to force the cable 22 against the cusp 50, as in the first embodiment. The barb 140 also assists in this regard. As would be appreciated by those skilled in the art, the barb 140 is not needed to practice the present invention. Moreover, as also should be appreciated by those skilled in the art, more than one barb 140 may be employed, if necessary or desired.

As in the first embodiment, the first securing member 134 (the trapezoidal member) preferably is made from a material that is more malleable than the material used to construct the second securing member 20 (the second disk). As before, it is preferred that the first securing member 134 be made from aluminum or an alloy thereof. The second securing member 20 preferably is made from a material such as steel. As before, those skilled in the art will readily appreciate that other materials may be used to construct the first securing member 134 and the second securing member 20 without departing from the scope of the invention.

FIG. 13 depicts a third embodiment of the invention, a security seal 142. This embodiment is similar to the second embodiment. The housing 12 contains a spring 136 and a trapezoidal member 134 (the first securing member). The second securing member 20 (the second disk 20) has been replaced with a trapezoidally-shaped second securing member 144. The trapezoidally-shaped second securing member 144 includes at least one barb on a top portion thereof, just as the first securing member 134 includes a barb 140. The second securing member 144 also includes one or more barbs 148 on the surface abutting the first securing member 134. Alternatively, the surface adjacent to the first securing member 134 may be knurled in the same fashion and for the same reason as the knurled circumferential surface 130 of the second disk 20.

In operation, the security seal 142 is expected to operate in essentially the same manner as the first two embodiments. In particular, when the free end 44 of the cable 22 is inserted through the bore 40, the free end 44 of the cable 22 pushes the first and second securing members 134, 144 in a direction toward the end cap 14. The spring 136 is suitably compressed to facilitate the insertion of the free end 44 of the cable 22 through the housing 12.

After the cable 22 is secured, a force applied in the reverse direction that tends to cause the cable 22 to become dislodged from the housing 12 will cause the spring 136 to apply a pressure into the first and second securing members 134, 144 that will apply a binding pressure on the cable 22 in the vicinity of the cusp 50, as in the previous examples. In addition, the barbs 140, 146 assist in discouraging the cable 22 from being removed from the housing 12.

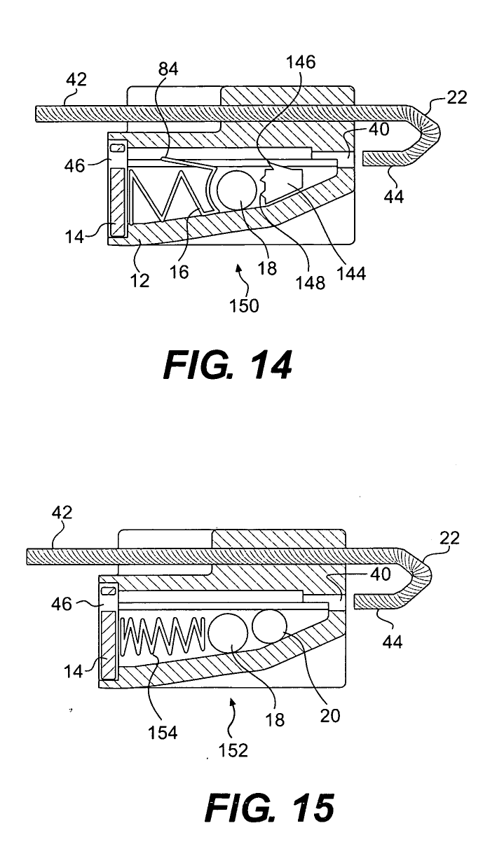

FIG. 14 provides a fourth embodiment of the invention, a security seal 150. This embodiment is similar to the third embodiment. The housing 12 contains the spring 16 and the first disk member 18 (the first securing member). The second securing member 144 is the same as the trapezoidally-shaped second securing member 144 illustrated in the third embodiment. The trapezoidally-shaped second securing member 144 includes the at least one barb 146 on a top portion thereof, as in the third embodiment. The second securing member 144 includes the barbs 148 on the surface abutting the first securing member 18. Alternatively, the surface adjacent to the first securing member 18 may be knurled in the same fashion and for the same reason as the knurled circumferential surface 130 of the second disk 20.

In operation, the security seal 150 is expected to operate in essentially the same manner as the first two embodiments. In particular, when the free end 44 of the cable 22 is inserted through the bore 40, the free end 44 of the cable 22 pushes the first and second securing members 18, 144 in a direction toward the end cap 14. The spring 16 compresses to facilitate the insertion of the free end 44 of the cable 22 through the housing 12.

After the cable 22 is secured, a force applied in the reverse direction that tends to cause the cable 22 to become dislodged from the housing 12 permits the spring 16 to apply a pressure into the first and second securing members 18, 144 that apply a binding pressure on the cable 22 in the vicinity of the cusp 50. In addition, the barbs 146, 148 assist in discouraging the cable 22 from being removed from the housing.

FIG. 15 shows a fifth embodiment of the invention, a security seal 152. This embodiment is similar to the first embodiment. In this embodiment, the spring 16 has been replaced with a coil spring 154. In all other respects, the fourth embodiment of the security seal 152 is the same as the first embodiment of the security seal 10. The housing 12 contains the first disk 18 and the second disk 20, as in the first embodiment.

In operation, the security seal 152 operates in essentially the same manner as the first three embodiments. In particular, when the free end 44 of the cable 22 is inserted through the bore 40, the free end 44 of the cable 22 pushes the first and second securing members 18, 20 in a direction toward the end cap 14.

After the cable 22 is secured, a force applied in the reverse direction that tends to cause the cable 22 to become dislodged from the housing 12 causes the knurled surface 130 of the second disk 20 to bite into the cable 22. This applies a binding pressure on the cable 22 in the vicinity of the cusp 50, as in the previous examples.

As would be appreciated by those skilled in the art, there are many alternative ways in which to practice the present invention, as would be understood by those skilled in the art. The embodiments described herein are merely representative of the broad scope of the invention.

What is claimed is:

1. A security device, comprising:
a housing having a bottom wall, an intermediate wall, and a top wall,
wherein the top wall and the intermediate wall define a first bore,
wherein the bottom wall and the intermediate wall define a central cavity, a second bore, and an end cap receiving opening, and
wherein the intermediate wall includes a recessed portion that defines a cusp at a predetermined distance interior to an end of the second bore within the housing;
an end cap disposed within the end cap receiving opening, the end cap defining a hole therethrough;
a resilient member disposed within the central cavity adjacent to the end cap;
a first securing member disposed within the cavity adjacent to the spring;
a second securing member disposed within the cavity adjacent to the first securing member; and
a cable with a first end and a second end,
wherein the first end is fixedly secured within the first bore, and
wherein the second end is insertable through the second bore and the hole in the end cap.

2. The security device of claim 1, wherein the housing and the end cap both comprise zinc or a zinc-containing alloy.

3. The security device of claim 1, wherein the resilient member is a spring that comprises steel or an iron-containing alloy.

4. The security device of claim 1, wherein the resilient member is a flat spring.

5. The security device of claim 4, wherein the flat spring comprises:
a first leg extending from a free end to a first bend;
a second leg extending from the first bend to a second bend;
a third leg extending from the second bend to a third bend;
a fourth leg extending from the third bend to a fourth bend;
a fifth leg extending from the fourth bend to a fifth bend;
a sixth leg extending from the fifth bend to a sixth bend; and
a seventh leg extending to a termination point from the sixth bend.

6. The security device of claim 5, wherein the second leg comprises a curve with a constant radius of curvature.

7. The security device of claim 1, wherein the first securing member is a first disk and the second securing member is a second disk.

8. The security device of claim 7, wherein the first disk comprises aluminum or an aluminum-containing alloy and has a smooth surface and wherein the second disk comprises steel or an iron containing alloy and has a knurled surface.

9. The security device of claim 1, wherein the first securing member is a disk and the second securing member is a trapezoidally-shaped member.

10. The security device of claim 9, wherein the trapezoidally-shaped member further comprises at least one barb on a surface facing the cable and at least one barb on a surface facing the disk.

11. The security device of claim 1, wherein the first securing member is a trapezoidally-shaped member and the second securing member is a disk.

12. The security device of claim 11, wherein the first securing member further comprises at least one barb on a surface facing the cable.

13. The security device of claim 1, wherein the first securing member and the second securing member are both trapezoidally-shaped members.

14. The security device of claim 1, wherein the resilient member is a coil spring.

15. The security device of claim 1, wherein the bottom wall of the housing defines a first inclined surface adjacent to the end cap receiving opening and a second inclined surface adjacent to the first inclined surface, the second inclined surface being angled to a greater degree than the first inclined angle.

16. The security device of claim 15, wherein the first inclined surface is angled at about 3 to 13 degrees from a reference line and the second inclined surface is angled about 19 to 29 degrees from the reference line.

17. The security device of claim 16, wherein the first inclined surface is angled at about 6 to 10 degrees from a reference line and the second inclined surface is angled about 22 to 26 degrees from the reference line.

18. The security device of claim 17, wherein the first inclined surface is angled at about 8 degrees from the reference line and the second inclined surface is angled about 24 degrees from the reference line.

19. The security device of claim 1, wherein the end cap is secured in the housing by crimping the housing around the end cap.

20. The security device of claim 1, wherein the cable comprises a plurality of wires stranded together.
